(19) United States
(12) Patent Application Publication
(10) Pub. No.: US 2026/0005235 A1
(43) Pub. Date: Jan. 1, 2026

(54) ELECTRODE ACTIVE MATERIAL AND BATTERY

(71) Applicant: TOYOTA JIDOSHA KABUSHIKI KAISHA, Toyota-shi (JP)

(72) Inventors: Mitsutoshi OTAKI, Nagoya-shi (JP); Masafumi Nose, Mishima-shi (JP)

(73) Assignee: TOYOTA JIDOSHA KABUSHIKI KAISHA, Toyota-shi (JP)

(21) Appl. No.: 19/093,461

(22) Filed: Mar. 28, 2025

(30) Foreign Application Priority Data
Jun. 27, 2024 (JP) 2024-104117

(51) Int. Cl. H01M 4/38; H01M 4/02; H01M 4/62

(52) U.S. Cl. CPC H01M 4/386; H01M 2004/021; H01M 2004/027; H01M 4/622; H01M 4/625

(57) ABSTRACT

The present disclosure solves the above problem by providing an electrode active material that contains an Si element and that includes a void in the interior of a primary particle, in which: a first void having a pore diameter of 30 nm or more and 100 nm or less and a second void having a pore diameter of 1 nm or more and 5 nm or less are included as the void; and when the amount of the first void is A and the amount of the second void is B, the ratio (A/B) of the A to the B is more than 0.10 and less than 17.00.

### CROSS-REFERENCE TO RELATED APPLICATION

This application claims priority to Japanese Patent Application No. 2024-104117 filed on Jun. 27, 2024. The disclosure of the above-identified application, including the specification, drawings, and claims, is incorporated by reference herein in its entirety.

### BACKGROUND

### 1. Technical Field

The present disclosure relates to an electrode active material and a battery.

### 2. Description of Related Art

In recent years, the development of batteries has been actively performed. For example, in the automobile industry, the development of a battery that is used in a battery electric vehicle (BEV) or a hybrid electric vehicle (HEV) has been advanced. Further, Si is known as an active material (electrode active material) that is used in the battery.

For example, Japanese Unexamined Patent Application Publication No. 2023-044620 (JP 2023-044620 A) discloses an active material that includes a silicon clathrate type II crystal phase, that includes voids in interiors of primary particles, and in which a void amount A of voids having pore diameters of 100 nm or less is more than 0.15 cc/g and 0.40 cc/g or less.

### SUMMARY

Si has a high theoretical capacity, and is effective for the increase in the energy density of the battery. On the other hand, Si causes a large volume change at the time of charge and discharge. The volume change amount is restrained by providing the void in the interior of the primary particle as described in JP 2023-044620 A, but there is further room for improvement about the volume change amount.

The present disclosure has been made in view of the above circumstance, and has a main object to provide an electrode active material in which the volume change due to the charge and discharge is small.

[1] An electrode active material that contains an Si element and that includes a void in an interior of a primary particle, wherein:
a first void having a pore diameter of 30 nm or more and 100 nm or less and a second void having a pore diameter of 1 nm or more and 5 nm or less are included as the void; and
when an amount of the first void is A and an amount of the second void is B, a ratio (A/B) of the A to the B is more than 0.10 and less than 17.00.

[2] The electrode active material according to [1], wherein the A/B is 10.00 or less.

[3] The electrode active material according to [1] or [2], wherein the A/B is 3.00 or more.

[4] The electrode active material according to any one of [1] to [3], wherein a silicon clathrate type II crystal phase is included as a main phase.

[5] A battery comprising:
a positive electrode active material layer;
a negative electrode active material layer; and
an electrolyte layer that is disposed between the positive electrode active material layer and the negative electrode active material layer, wherein
the negative electrode active material layer contains the electrode active material according to any one of [1] to [4], as a negative electrode active material.

The present disclosure exerts an effect of being capable of obtaining an electrode active material in which the volume change due to the charge and discharge is small.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram exemplifying a crystal phase of an electrode active material;

FIG. 1B is a diagram exemplifying a crystal phase of an electrode active material;

FIG. 1C is a diagram exemplifying a crystal phase of an electrode active material; and

FIG. 2 is a schematic sectional view exemplifying a battery in the present disclosure.

### DETAILED DESCRIPTION OF EMBODIMENTS

An electrode active material and a battery in the present disclosure will be described below in detail.

### A. Electrode Active Material

The electrode active material in the present disclosure contains an Si element, and includes a void in the interior of a primary particle. Further, as the above void, the electrode active material in the present disclosure includes a first void having a pore diameter of 30 nm or more and 100 nm or less and a second void having a pore diameter of 1 nm or more and 5 nm or less. When the amount of the first void is A and the amount of the second void is B, the ratio (A/B) of the A to the B is more than 0.10 and less than 17.00.

In the present disclosure, the electrode active material includes the predetermined first void and second void, and the ratio of the amount A of the first void to the amount B of the second void is more than 0.10 and less than 17.00. Therefore, it is possible to reduce the volume change due to the charge and discharge.

As described in JP 2023-044620 A, a porous Si including the void in the interior of the primary particle has been studied for restraining the volume change. Particularly, it is thought that the existence of minute voids having sizes (pore diameters) of 100 nm or less can uniformly ease the volume change due to the discharge. Meanwhile, the inventors have diligently studied the size of the void, and have found that it is possible to further restrain the volume change, by adjusting, among the minute voids, the ratio between the amount of a relatively coarse void (first void) having a size of 30 nm or more and 100 nm or less and the amount of a relatively minute void (second void) having a size of 1 nm or more and 5 nm or less, to a predetermined ratio. As for the first void, the degree of the absorption of expansion and contraction is large, but there is fear that a reaction concentrates at the vicinity of the first void. As a result, when the ratio of the first void is excessively large, it is thought that there is fear that it is not possible to sufficiently restrain the volume change as the whole of the active material. In this regard, it is thought that the existence of the second void makes it possible to uniform the reaction in the active material and to sufficiently restrain the volume change as the whole of the active material.

The electrode active material in the present disclosure contains the Si element, and includes the void in the interior of the primary particle. The electrode active material in the present disclosure is a so-called porous Si (p-Si).

As the void, the electrode active material in the present disclosure includes the first void having a pore diameter of 30 nm or more and 100 nm or less and the second void having a pore diameter of 1 nm or more and 5 nm or less. Further, when the amount of the first void is A and the amount of the second void is B, the ratio (A/B) of the A to the B is more than 0.10 and less than 17.00. It can be confirmed that the electrode active material includes the void and includes the first void and the second void, by the observation with a scanning electron microscope (SEM).

The A/B may be 0.50 or more, may be 1.00 or more, may be 3.00 or more, or may be 5.00 or more. Further, the A/B may be 16.00 or less, may be 15.00 or less, may be 13.00 or less, may be 10.00 or less, or may be 8.00 or less. The first void amount A and the second void amount B can be evaluated, for example, by mercury porosimeter measurement, BET measurement, gas adsorption method, 3D-SEM, or 3D-TEM.

The amount of the first void is not particularly limited as long as the above-described A/B is satisfied. The amount of the first void is 0.050 cc/g or more, for example, and may be 0.100 cc/g or more, or may be 0.150 cc/g or more. On the other hand, the amount of the first void is 0.300 cc/g or less, for example, and may be 0.250 cc/g or less, or may be 0.200 cc/g or less.

The amount of the second void is not particularly limited as long as the above-described A/B is satisfied. The amount of the second void is 0.005 cc/g or more, for example, and may be 0.010 cc/g or more, may be 0.030 cc/g or more, or may be 0.050 cc/g or more. On the other hand, the amount of the second void is 0.150 cc/g or less, for example, and 0.100 cc/g or less, or may be 0.20 cc/g or less.

Further, as the above void, the electrode active material may include a third void having a pore diameter of more than 5 nm and less than 30 nm. Further, as the above void, the electrode active material may include a fourth void having a pore diameter of more than 100 nm. The amount of the third void is not particularly limited, and for example, is 0.050 cc/g or more and 0.250 cc/g or less. Further, the amount of the fourth void is not particularly limited, and for example, is 0.200 cc/g or more and 0.400 cc/g or less. The amounts of the third void and the fourth void can be evaluated by the same method as the above-described method for the amounts of the first void and the second void.

The void ratio of the electrode active material is not particularly limited. The void ratio of the electrode active material is 4% or more, for example, and may be 10% or more. Further, the void ratio is 40% or less, for example, and may be 20% or less. For example, the void ratio can be evaluated in the following procedure. First, a section image of the electrode active material is acquired by a SEM. From the obtained image, a silicon portion and a void portion are distinguished and are binarized using image analysis software. The areas of the silicon portion and the void portion are evaluated, and the void ratio (%) is calculated from the following expression.

Void Ratio (%)=100×(Void Portion Area)/((Silicon Portion Area)+(Void Portion 15 Area))

The electrode active material in the present disclosure contains the Si element. The electrode active material may be an elemental Si, may be an alloy (Si alloy) containing Si as a main component, or may be an Si oxide. The ratio of the Si element in the Si alloy is 50 mol % or more and 95 mol % or less, for example.

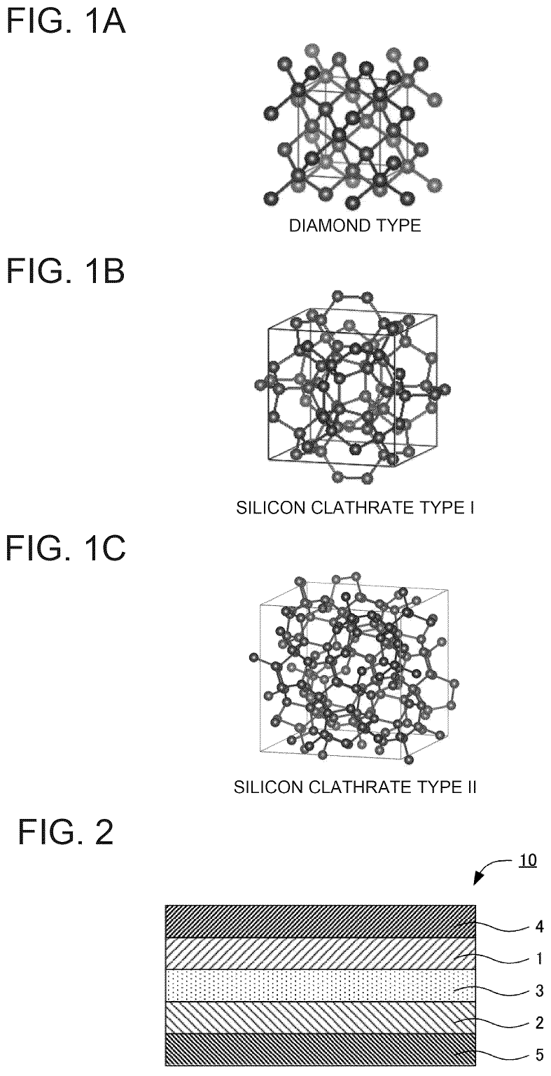

Further, the electrode active material in the present disclosure may include a predetermined crystal phase. That is, the electrode active material may be a crystalline porous Si. The porous Si can include a diamond type crystal phase shown in FIG. 1A, a silicon clathrate type I crystal phase shown in FIG. 1B, and a silicon clathrate type II crystal phase shown in FIG. 1C. Note that, a porous Si including a clathrate type crystal phase is referred to as a porous clathrate Si. The electrode active material in the present disclosure may include one of the above-described crystal phases, or may include two or more of the above-described crystal phases. The crystal phase in the electrode active material can be confirmed by an X-ray diffraction measurement (XRD measurement) in which a CuKα ray is used. Here, as shown in FIG. 1A, in the diamond type crystal phase, a tetrahedron is formed by a plurality of Si elements. The tetrahedron does not include, in the interior, a space that can envelop a metal ion such as a Li ion. In contrast, as shown in FIG. 1B and FIG. 1C, in the silicon clathrate type I crystal phase and the silicon clathrate type II crystal phase, framework atoms have a basket-shaped structure (cage), and the metal ion such as the Li ion can be placed in the basket-shaped structure. Therefore, it is through that it is possible to further restrain the expansion and contraction of a composite particle. Therefore, it is preferable that the electrode active material in the present disclosure includes at least one of the silicon clathrate type I crystal phase and the silicon clathrate type II crystal phase. Particularly, it is preferable that the electrode active material in the present disclosure includes the silicon clathrate type II crystal phase as a main phase. The “main phase” is a crystal phase in which a belonging peak has the highest diffraction intensity among peaks observed in the X-ray diffraction measurement. The ratio of the silicon clathrate type II crystal phase included in the electrode active material is 80 weight % or more, for example, and may be 85 weight % or more, may be 90 weight % or more, or may be 95 weight % or more. Further, the ratio of the silicon clathrate type II crystal phase included in the electrode active material may be 100 weight %, or may be less than 100 weight %. The ratio of the crystal phase can be evaluated using a reference intensity ratio method (RIR method).

The diamond type crystal phase has typical peaks at positions of 2θ=28.44°, 47.31°, 56.10°, 69.17°, and 76.37°, in the X-ray diffraction measurement in which the CuKα ray is used. Further, the silicon clathrate type I crystal phase has typical peaks at positions of 2θ=19.44°, 21.32°, 30.33°, 31.60°, 32.82°, 36.29°, 52.39°, and 55.49°, in the X-ray diffraction measurement in which the CuKα ray is used. Further, the silicon clathrate type II crystal phase has typical peaks at positions of 2θ=20.09°, 21.00°, 26.51°, 31.72°, 36.26°, and 53.01°, in the X-ray diffraction measurement in which the CuKΔ ray is used. Each of the above-described peak positions may be shifted in a range of ±0.50°, may be shifted in a range of ±0.30°, or may be shifted in a range of ±0.10°.

Here, as described above, the void in the present disclosure can be observed by the SEM. On the other hand, the space (the distance between atoms) in the basket-shaped structure in the silicon clathrate type I or the silicon clathrate type II has generally Å in size, and therefore, cannot be observed by the SEM. Accordingly, the space in the basket-shaped structure does not fall under the void in the present disclosure.

The electrode active material in the present disclosure may have the primary particle, or may have a secondary particle in which primary particles are aggregated. The average particle diameter of the primary particle is 150 nm or more, for example, and may be 200 nm or more, or may be 500 nm or more. On the other hand, the average particle diameter of the primary particle is 3000 nm or less, for example, and may be 1500 nm or less, or may be 1000 nm or less. Further, the average particle diameter of the secondary particle is 1 μm or more, for example, and may be 2 μm or more, or may be 5 μm or more. On the other hand, the average particle diameter of the secondary particle is 60 μm or less, for example, and may be 40 μm or less. Note that, the average particle diameter can be evaluated by the observation with the SEM, for example. It is preferable that the number of samples is large. The number of samples is 20 or more, for example, and may be 50 or more, or may be 100 or more.

Examples of the production method for the porous Si include a method of producing an alloy (Li—Si alloy) of Li and Si and removing Li from the Li—Si alloy. For example, the Li—Si alloy is obtained by mixing Li and Si. Examples of the method of removing Li from the Li—Si alloy include a method of reacting the Li—Si alloy with a Li extraction material. Examples of the Li extraction material include alcohols such as methanol and acids such as acetic acid. The amount of the first void and the amount of the second void can be adjusted by altering the ratio between Li and Si and the condition for the Li extraction.

Examples of the production method for the crystalline porous Si include a method of producing an Na—Si alloy by mixing and heating a Si source and a Na source such as NaH and decreasing the amount of Na in the Na—Si alloy by heating the Na—Si alloy, to generate the silicon clathrate type crystal phase. The porous clathrate Si can be produced using the above porous Si as the above Si. Further, as described later in Examples, in the production of the porous clathrate Si, it is likely that washing with an acid such as HF is performed for removing a by-product. In this respect, the amount of the first void and the amount of the second void can be adjusted by altering the condition for the washing.

The electrode active material in the present disclosure may be used as a positive electrode active material in a battery, or may be used as a negative electrode active material. Preferably, the electrode active material in the present disclosure should be used as the negative electrode active material. This is because a battery having a higher capacity is obtained.

### B. Battery

FIG. 2 is a schematic sectional view exemplifying a battery in the present disclosure. A battery 10 shown in FIG. 2 includes a positive electrode active material layer 1, a negative electrode active material layer 2, an electrolyte layer 3 that is disposed between the positive electrode active material layer 1 and the negative electrode active material layer 2, a positive electrode current collector 4 that performs current collection for the positive electrode active material layer 1, and a negative electrode current collector 5 that performs current collection for the negative electrode active material layer 2. Particularly, in the present disclosure, the negative electrode active material layer 2 contains the above-described electrode active material as the negative electrode active material.

In the present disclosure, since the negative electrode active material layer contains the above-described electrode active material, it is possible to obtain a battery in which the volume change due to the charge and discharge is small.

### 1. Negative Electrode Active Material Layer

The negative electrode active material layer contains the above-described electrode active material as the negative electrode active material. The electrode active material has the same content as the content described in “A. Electrode Active Material”. The ratio of the negative electrode active material in the negative electrode active material layer is 20 weight % or more, for example, and may be 30 weight % or more, or may be 40 weight % or more. When the ratio of the negative electrode active material is excessively small, there is a possibility that a sufficient energy density cannot be obtained. On the other hand, the ratio of the negative electrode active material is 80 weight % or less, for example, and may be and 70 weight % or less, or may be 60 weight % or less. When the ratio of the negative electrode active material is excessively large, there is a possibility that the ion conductivity and electron conductivity in the negative electrode active material layer relatively decreases.

The negative electrode active material layer may contain at least one of an electrolyte, a conductive material, and a binder, as necessary. Examples of the electrolyte include electrolytes in “3. Electrolyte Layer” described later. Examples of the conductive material include a carbon material, a metal particle, and a conductive polymer. Examples of the carbon material include particulate carbon materials such as acetylene black (AB) and Ketjen black (KB), and fibrous carbon materials such as a carbon fiber, a carbon nanotube (CNT) and a carbon nanofiber (CNF). Further, examples of the binder include a rubber binder and a fluoride binder.

The thickness of the negative electrode active material layer is 1 μm or more and 100 μm or less, for example.

### 2. Positive Electrode Active Material Layer

The positive electrode active material layer contains at least a positive electrode active material. Further, the positive electrode active material layer may contain at least one of an electrolyte, a conductive material, and a binder, as necessary. The electrolyte, the conductive material and the binder have the same contents as the contents described in “1. Negative Electrode Active Material Layer”.

Examples of the positive electrode active material include an oxide active material. Examples of the oxide active material include bedded salt type active materials such as LiCoO₂, LiMnO₂, LiNiO₂, LiVO₂, and LiNi_{1/3}Co_{1/3}Mn_{1/3}O₂, spinel type active materials such as LiMn₂O₄, Li₄Ti₅O₁₂, and Li(Ni_{0.5}Mn_{1.5})O₄, and olivine type active materials such as LiFePO₄, LiMnPO₄, LiNiPO₄, and LiCoPO₄.

A coat layer containing a Li-ion conducting oxide may be formed on a surface of the oxide active material. This is because the reaction between the oxide active material and a solid electrolyte (particularly, a sulfide solid electrolyte) can be restrained. Examples of the Li-ion conducting oxide include LiNbO₃, Li₄Ti₅O₁₂, and Li₃PO₄. The thickness of the coat layer is 1 nm or more and 30 nm or less, for example.

The form of the positive electrode active material is a particle form, for example. Although not particularly limited, the average particle diameter (D₅₀) of the positive electrode active material is 10 nm or more, for example, and may be 100 nm or more. On the other hand, the average particle diameter (D₅₀) of the positive electrode active material is 50 μm or less, for example, and may be 20 μm or less. The average particle diameter (D₅₀) can be calculated based on the measurement with a laser diffraction particle size analyzer or the scanning electron microscope (SEM), for example. The ratio of the positive electrode active material in the positive electrode active material layer is 50 weight % or more and 80 weight % or less, for example.

The thickness of the positive electrode active material layer is 1 μm or more and 100 μm or less, for example.

### 3. Electrolyte Layer

The electrolyte layer is a layer that is disposed between the positive electrode active material layer and the negative electrode active material layer, and contains at least an electrolyte. Further, the electrolyte layer may contain a binder as necessary. The binder has the same content as the content described in “1. Negative Electrode Active Material Layer”.

The electrolyte may be a solid electrolyte, or may be a liquid electrolyte (electrolytic solution). Examples of the solid electrolyte include inorganic solid electrolytes such as a sulfide solid electrolyte, an oxide solid electrolyte, a nitride solid electrolyte, and a halide solid electrolyte, and organic polyelectrolytes such as a polymer electrolyte. Note that, an electrolyte layer containing the inorganic solid electrolyte as the electrolyte is referred to as a solid electrolyte layer. It is preferable that the sulfide solid electrolyte contains sulfur(S) as a main component of an anion element. It is preferable that the oxide solid electrolyte contains oxygen (O) as a main component of an anion element. It is preferable that the halide solid electrolyte contains halogen as a main component of an anion. Among them, the sulfide solid electrolyte is preferable.

Examples of the sulfide solid electrolyte include a solid electrolyte that contains a Li element, an X element (X is at least one kind of P, As, Sb, Si, Ge, Sn, B, Al, Ga, and In), and a S element. Further, the sulfide solid electrolyte may further contain at least one of an O element and a halogen element. Examples of the halogen element include a F element, a Cl element, a Br element, and an I element. The sulfide solid electrolyte may be glass (amorphous material), or may be glass ceramics. Examples of the sulfide solid electrolyte include Li₂S-P₂S₅, LiI-Li₂S-P₂S₅, LiI-LiBr-Li₂S-P₂S₅, Li₂S-SiS₂, Li₂S-GeS₂, and Li₂S-P₂S₅-GeS₂.

It is preferable that the electrolytic solution contains a supporting electrolyte and a solvent. Examples of the supporting electrolyte (lithium salt) of an electrolytic solution having lithium-ion conductivity include inorganic lithium salts such as LiPF₆, LiBF₄, LiClO₄, and LiAsF₆, and organic lithium salts such as LiCF₃SO₃, LiN(CF₃SO₂)₂, LiN(C₂F₅SO₂)₂, LiN(FSO₂)₂, and LiC(CF₃SO₂)₃. Examples of the solvent that is used in the electrolytic solution include cyclic esters (cyclic carbonates) such as ethylene carbonate (EC), propylene carbonate (PC), and butylene carbonate (BC), and chain esters (chain carbonates) such as dimethyl carbonate (DMC), diethyl carbonate (DEC), and ethyl methyl carbonate (EMC). It is preferable that the electrolytic solution contains two or more kinds of solvents.

The thickness of the electrolyte layer is 1 μm or more and 100 μm or less, for example.

### 4. Other Constitutions

It is preferable that the battery in the present disclosure includes a positive electrode current collector that performs current collection for the positive electrode active material layer and a negative electrode current collector that performs current collection for the negative electrode active material layer. Examples of the material of the positive electrode current collector include metals such as SUS, Ni, Cr, Au, Pt, Fe, Ti, and Zn. Further, a plated layer or deposited layer containing Ni, Cr, and C may be formed on a surface of the positive electrode current collector. On the other hand, examples of the material of the negative electrode current collector include Cu and a Cu alloy. A plated layer or deposited layer containing Ni, Cr, and C may be formed on a surface of the negative electrode current collector.

The battery in the present disclosure may further include a confining jig that gives confining pressure to the positive electrode active material layer, the electrolyte layer, and the negative electrode active material layer, along the thickness direction. Particularly, in the case where the electrolyte layer is a solid electrolyte layer, it is preferable to give the confining pressure, for forming a good ion conducting path and electron conducting path. The confining pressure is 0.1 MPa or higher and 100 MPa or lower, for example.

### 5. Battery

The kind of the battery in the present disclosure is not particularly limited, and is typically a lithium-ion battery. Further, the battery in the present disclosure may be a liquid-state battery, or may be a solid-state battery. Note that, a battery including the above-described solid electrolyte layer is referred to as a solid-state battery. Further, the solid-state battery may be a semi-solid-state battery, or may be an all-solid-state battery. In the case where the solid electrolyte layer in the solid-state battery contains only the above-described inorganic solid electrolyte as the electrolyte, the above solid-state battery is referred to as an all-solid-state battery.

Further, the battery in the present disclosure may be a primary battery, or may be a secondary battery, and preferably, should be a secondary battery. This is because the secondary battery can be repeatedly charged and discharged and is useful as an in-vehicle battery, for example.

The use application of the battery in the present disclosure is not particularly limited. For example, the battery in the present disclosure is used as an electric power source of a vehicle such as a hybrid electric vehicle (HEV), a plug-in hybrid electric vehicle (PHEV), a battery electric vehicle (BEV), a gasoline vehicle, and a diesel vehicle. Particularly, it is preferable that the battery in the present disclosure is used as an electric power source for the drive of the hybrid electric vehicle (HEV), the plug-in hybrid electric vehicle (PHEV), or the battery electric vehicle (BEV). Further, the battery in the present disclosure may be used as an electric power source of a movable body (for example, a train, a ship, and an airplane) other than a vehicle, or may be used as an electric power source of an electric product such as an information processing device.

Note that, the present disclosure is not limited to the above embodiment. The above embodiment is an example, and the technical scope of the present disclosure includes all embodiments that have a substantially identical configuration to the technical idea described in the claims in the present disclosure and that exert the same function effect.

### Example 1

### Production of Electrode Active Material

Li metal and Si powder were weighted such that the mole ratio was 4:1, were mixed in a mortar at room temperature under an Ar atmosphere for 0.5 hours, and thereby were reacted. Thereby, Li₄Si was obtained. The obtained Li₄Si was reacted with ethanol under the Ar atmosphere. The obtained reaction product is thought to contain Si and CH₃CH₂OLi. This reaction product was filtered, and a solid content separated by filtering was dried at 120° C. for 3 hours or more, so that a powdery porous Si was obtained. Using the obtained Si, a Na—Si alloy was produced, while NaH was used as a Na source. Note that, as NaH, NaH that was previously washed by hexane was used. NaH and the porous Si were weighted such that the mole ratio was 1.05:1, and were mixed using a cutter mill. The mixture of NaH and the porous Si was heated at 475° C. under the Ar atmosphere in a heating furnace for 40 hours, and thereby, a powdery Na—Si alloy was obtained.

Using the obtained Na—Si alloy, a silicon clathrate generation step by a solid phase method was performed while AlF₃ was used as a Na trapping agent. The Na—Si alloy and AlF₃ were weighted such that the mole ratio was 1:0.35, and were mixed using a cutter mill, so that a reaction material was obtained. The obtained powdery reaction material was put in a reaction container made of stainless steel, and was heated and reacted at 310° C. under the Ar atmosphere in the heating furnace for 60 hours. The obtained reaction product is thought to contain a targeted active material as well as NaF and Al as by-products. This reaction product was washed using a mixed solvent in which HNO₃ and H₂O were mixed at a volume ratio of 10:90. Thereby, the by-products in the reaction product were removed. After the washing, filtering was performed, and a solid content separated by filtering was dried at 120° C. for 3 hours or more, so that powder was obtained. The obtained powder was immersed in a HF aqueous solution for 3 hours, and thereby, was washed (HF washing). Thereby, an electrode active material including the void in the interior of the primary particle was produced. Note that, the washing was performed under a room temperature (25° C.) environment, while the temperature of the HF aqueous solution was not controlled. In this respect, it is thought that the temperature of the HF aqueous solution was increased to about 40° C. by the heat generated by the washing. Further, the XRD measurement of the produced electrode active material was performed, and although the data is not particularly shown, the electrode active material included the silicon clathrate type II crystal phase as the main phase. The same goes for Examples 2 to 4 and Comparative Examples 1 and 2 described later.

### Production of Battery for Evaluation

First, a positive electrode was produced as described below. A 5 wt % butyl butyrate solution containing butyl butyrate and a PVDF binder, a positive electrode active material (LiNi_{1/3}Co_{1/3}Mn_{1/3}O₂; average particle diameter 6 μm), a sulfide solid electrolyte (Li₂S-P₂S₅ glass ceramic), and a conduction aid (VGCF) were added in a polypropylene container, and were stirred for 30 seconds using an ultrasonic dispersion device (UH-50 manufactured by SMT CO., LTD). Next, the above container was shaken for 3 minutes by a shaker (TTM-1 manufactured by SIBATA SCIENTIFIC TECHNOLOGY LTD.), and was stirred for 30 seconds by the ultrasonic dispersion device. Furthermore, the above container was shaken for 3 minutes, so that a positive electrode slurry was obtained. The positive electrode slurry was applied on a positive electrode current collector (Al foil; manufactured by SHOWA DENKO K. K.) by a blade method using an applicator. Then, drying was performed on a hot plate at 100° C. for 30 minutes. Thereby, a positive electrode including the positive electrode current collector and the positive electrode active material layer was obtained.

Next, a negative electrode was produced as described below. A 5 wt % butyl butyrate solution containing butyl butyrate and a PVDF binder, a conduction aid (VGCF), the above electrode active material (porous Si), and a sulfide solid electrolyte (Li₂S-P₂S₅ glass ceramic) were added in a polypropylene container, and were stirred for 30 seconds by the ultrasonic dispersion device (UH-50 manufactured by SMT CO., LTD). Next, the above container was shaken for 30 minutes by the shaker (TTM-1 manufactured by SIBATA SCIENTIFIC TECHNOLOGY LTD.), so that a negative electrode slurry was obtained. The negative electrode slurry was applied on a negative electrode current collector (Cu foil; manufactured by UACJ Corporation) by the blade method using the applicator. Then, drying was performed on the hot plate at 100° C. for 30 minutes. Thereby, a negative electrode including the negative electrode current collector and the negative electrode active material layer was obtained. Note that, the negative electrode was pressed at 60 kN/cm at 25° C. using a roll press machine.

Next, a transfer member including a solid electrolyte layer was produced as described below.

A 5 wt % heptane solution containing heptane and a BR binder, and a sulfide solid electrolyte (Li₂S-P₂S₅ glass ceramic) were added, and were stirred for 30 seconds by the ultrasonic dispersion device (UH-50 manufactured by SMT CO., LTD). Next, the container was shaken for 30 minutes by the shaker (TTM-1 manufactured by SIBATA SCIENTIFIC TECHNOLOGY LTD.). Thereby, a slurry was obtained. The slurry was applied on a base material (Al foil) by the blade method using the applicator. Then, drying was performed on the hot plate at 100° C. for 30 minutes. Thereby, a transfer member including the base material and the solid electrolyte layer was obtained.

The positive electrode and the transfer member were put on each other, such that the positive electrode active material layer and the solid electrolyte layer faced each other. This was pressed at 100 kN/cm at 165° C. using the roll press machine. After the press, the base material was peeled, so that a positive electrode laminate body was obtained. Further, the negative electrode and the transfer member were put on each other, such that the negative electrode active material layer and the solid electrolyte layer faced each other. This was pressed at 100 MPa at 25° C. for 10 seconds, using a planar uniaxial press machine. After the press, the base material was peeled, so that a negative electrode laminate body was obtained. Note that, the negative electrode laminate body and the positive electrode laminate body were produced such that the area of the negative electrode laminate body was larger than the area of the positive electrode laminate body. The positive electrode laminate body and the negative electrode laminate body were put on each other such that the solid electrolyte layers faced each other, and were pressed at 200 MPa at 120° C. for 1 minute, by the planar uniaxial press machine. Thereby, a battery (all-solid-state battery) for evaluation was obtained.

### Example 2

An electrode active material (negative electrode active material; porous Si) and an all-solid-state battery were produced similarly to Example 1, except that the immersion time in the HF washing was altered to 1 hour and the temperature of the HF aqueous solution during the immersion was maintained at 10° C. using coolant.

### Example 3

An electrode active material (negative electrode active material; porous Si) and an all-solid-state battery were produced similarly to Example 1, except that the temperature of the HF aqueous solution during the immersion was maintained at 10° C. using coolant, in the HF washing.

### Example 4

The firing of the mixture of the Na—Si alloy and AlF₃ was performed at 345° C. for 20 hours. Further, the immersion time in the HF washing was altered to 5 hours, and the temperature of the HF aqueous solution during the immersion was maintained at 0° C. using ice water. Except them, an electrode active material and an all-solid-state battery were produced similarly to Example 1.

### Comparative Example 1

An electrode active material and an all-solid-state battery were produced similarly to Example 1, except that the immersion time in the HF washing was altered to 1 hour.

### Comparative Example 2

An electrode active material and an all-solid-state battery were produced similarly to Example 1, except that the ratio between the Li metal and the Si powder was altered to a mole ratio of 4.75:1 and the immersion time in the HF washing was altered to 1 hour.

### Evaluation

### Measurement of Void Amount

For each of the electrode active materials produced in the examples and the comparative examples, the first void amount A and the second void amount B were measured using BEL SORP MAX II of MicrotracBEL Corp. The ratio of the first void amount A to the second void amount B was calculated from the obtained measurement values. The results are shown in Table 1. Note that, the first void amount A was evaluated by subtracting the amount of voids having pore diameters of less than 30 nm from the amount of voids having pore diameters of more than 100 nm.

### Measurement of Expansion Rate

Each of the all-solid-state batteries produced in the examples and the comparative examples was confined by a confining jig, and a constant-current constant-voltage charge was performed at 10 hour rate (1/10 C) to 4.55 V. The expansion rate was calculated from the variation amount of the confining pressure. The evaluation was relatively performed while the expansion rate in Comparative Example 1 was regarded as 100. The results are shown in Table 1.

TABLE 1

| | Second Void | Void Amount | | First Void | | Expansion |
|---|---|---|---|---|---|---|
| | Amount B | less than 30 | more than | Amount A | | Rate |
| | (cc/g) | nm (cc/g) | 100 nm (cc/g) | (cc/g) | A/B | (relative value) |
| Comparative | 0.0083 | 0.1674 | 0.3150 | 0.1476 | 17.78 | 100 |
| Example 1 | | | | | | |
| Comparative | 0.0136 | 0.1200 | 0.3584 | 0.2384 | 17.54 | 91 |
| Example 2 | | | | | | |
| Example 1 | 0.0114 | 0.1858 | 0.3600 | 0.1742 | 15.28 | 85 |
| Example 2 | 0.0225 | 0.2344 | 0.3589 | 0.1245 | 5.53 | 55 |
| Example 3 | 0.0214 | 0.1110 | 0.2487 | 0.1377 | 6.43 | 61 |
| Example 4 | 0.0388 | 0.1407 | 0.2940 | 0.1533 | 3.95 | 45 |

As shown in Table 1, in Examples 1 to 4, the expansion rate is significantly small than in Comparative Examples 1 and 2, and it has been confirmed that the volume change due to the charge and discharge is small in the electrode active material in the present disclosure.

What is claimed is:

1. An electrode active material that contains an Si element and that includes a void in an interior of a primary particle, wherein:
a first void having a pore diameter of 30 nm or more and 100 nm or less and a second void having a pore diameter of 1 nm or more and 5 nm or less are included as the void; and
when an amount of the first void is A and an amount of the second void is B, a ratio (A/B) of the A to the B is more than 0.10 and less than 17.00.

2. The electrode active material according to claim 1, wherein the A/B is 10.00 or less.

3. The electrode active material according to claim 1, wherein the A/B is 3.00 or more.

4. The electrode active material according to claim 1, wherein a silicon clathrate type II crystal phase is included as a main phase.

5. A battery comprising:
a positive electrode active material layer;
a negative electrode active material layer; and
an electrolyte layer that is disposed between the positive electrode active material layer and the negative electrode active material layer, wherein
the negative electrode active material layer contains the electrode active material according to claim 1, as a negative electrode active material.
